(19) United States
(12) Patent Application Publication
(10) Pub. No.: US 2015/0053024 A1
(43) Pub. Date: Feb. 26, 2015

(54) TORQUE MEASURING APPARATUS USING MAGNETIC BODIES

(71) Applicant: Daegu Gyeongbuk Institute of Science and Technology, Daegu (KR)

(72) Inventors: Tae Hun KANG, Daegu (KR); Jeon II MOON, Daegu (KR)

(73) Assignee: Daegu Gyeongbuk Institute of Science and Technology, Daegu (KR)

(21) Appl. No.: 14/050,379

(22) Filed: Oct. 10, 2013

(30) Foreign Application Priority Data
Aug. 21, 2013 (KR) 10-2013-0099117

(51) Int. Cl. G01L 3/10

(52) U.S. Cl. CPC G01L 3/101
USPC 73/862.193

(57) ABSTRACT

Provided is a torque measuring apparatus using magnetic bodies, the torque measuring apparatus including: an input link whose one end is connected to a driver and rotated in one direction by the driver; a first displacement sensor disposed at the other end of the input link, and controlling rotation displacement of the input link and the driver; a plurality of first magnetic bodies connected to the input link via a connection member and rotating in the one direction; a plurality of second magnetic bodies disposed between the plurality of first magnetic bodies; an output link supporting the plurality of second magnetic bodies and rotated by the pluralities of first and second magnetic bodies, wherein the plurality of second magnetic bodies are disposed inside the output link; and a second displacement sensor closely disposed to one surface of the output link and measuring rotation displacement of the output link.

### CROSS-REFERENCE TO RELATED PATENT APPLICATION

This application claims the benefit of Korean Patent Application No. 10-2013-0099117, filed on Aug. 21, 2013, in the Korean Intellectual Property Office, the disclosure of which is incorporated herein in its entirety by reference.

### BACKGROUND OF THE INVENTION

1. Field of the Invention

The present invention relates to a torque measuring apparatus using magnetic bodies, and more particularly, to a torque measuring apparatus using magnetic bodies, wherein an external force is measured by using a physical phenomenon between the magnetic bodies.

2. Description of the Related Art

Referring to the Description of the Related Art in KR2012-0079294, torque generally denotes a force that causes an object to rotate around a central shaft, and is also referred to as torsional moment.

An apparatus such as a load cell or a strength gauge is widely used to control or measure the torque.

However, since the load cell or the strength gauge not only has a complex structure, but also has a large volume, it is inconvenient and restricted to directly mount and use the load cell or the strength gauge on a rotation shaft of any one of various medical devices or industrial machines, where a required tool is rotated by receiving rotation power of a motor, and an installation charge is high.

### SUMMARY OF THE INVENTION

The present invention provides a torque measuring apparatus using magnetic bodies, wherein an external force is measured by using an output link that is rotated by the magnetic bodies, an input link that rotates the magnetic bodies, a first displacement sensor for measuring rotation displacement of the input link, and a second displacement sensor for measuring rotation displacement of the output link.

According to an aspect of the present invention, there is provided a torque measuring apparatus using magnetic bodies, the torque measuring apparatus including: an input link whose one end is connected to a driver and rotated in one direction by the driver; a first displacement sensor disposed at the other end of the input link, and controlling rotation displacement of the input link and the driver; a plurality of first magnetic bodies connected to the input link via a connection member and rotating in the one direction; a plurality of second magnetic bodies disposed between the plurality of first magnetic bodies; an output link supporting the plurality of second magnetic bodies and rotated by the pluralities of first and second magnetic bodies, wherein the plurality of second magnetic bodies are disposed inside the output link; and a second displacement sensor closely disposed to one surface of the output link and measuring rotation displacement of the output link.

The connection member may include: a cylindrical body having a through hole through which the input link penetrates; and a magnetic body protruding outside the body and including a plurality of connection ends connected to the plurality of first magnetic bodies.

The output link may include: a hollow body; and a magnetic body including a plurality of protruding ends protruding inside the body to support the plurality of second magnetic bodies.

The pluralities of first and second magnetic bodies may be adjacently disposed, wherein same polarities of the pluralities of first and second magnetic bodies may be adjacently disposed. Alternatively, different polarities of the plurality of first and second magnetic bodies may be adjacently disposed.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of a torque measuring apparatus using magnetic bodies, according to an embodiment of the present invention;

FIG. 2 is a diagram showing an arrangement of a first magnetic body and a second magnetic body disposed in an output link of FIG. 1, according to an embodiment of the present invention;

FIG. 3 is a diagram showing an arrangement of the first magnetic body and the second magnetic body disposed in the output link of FIG. 1, according to another embodiment of the present invention;

FIG. 4 is a diagram of a state where a repulsive force is generated between the first magnetic body and the second magnetic body; and

FIG. 5 is a diagram of a state where an attractive force is generated between the first magnetic body and the second magnetic body.

### DETAILED DESCRIPTION OF THE INVENTION

Hereinafter, the present invention will be described more fully with reference to the accompanying drawings, in which exemplary embodiments of the invention are shown. Terms used herein shall not be limitedly construed as general or dictionary meanings, but shall be construed as meanings and concepts suitable to technical aspects of the present invention based on the principle that the inventor can suitably define the terms to describe the invention best way possible.

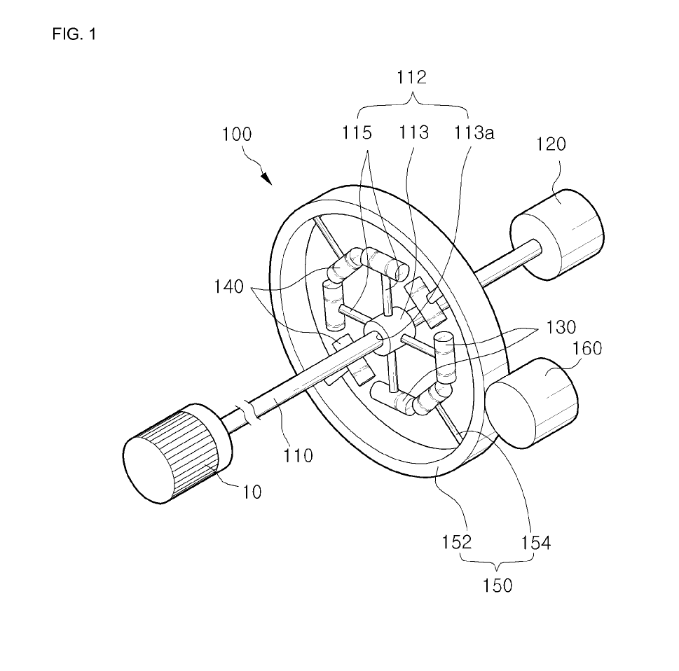

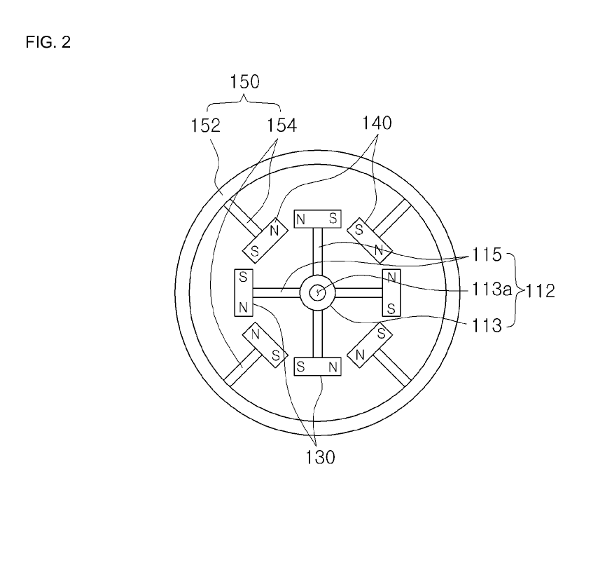

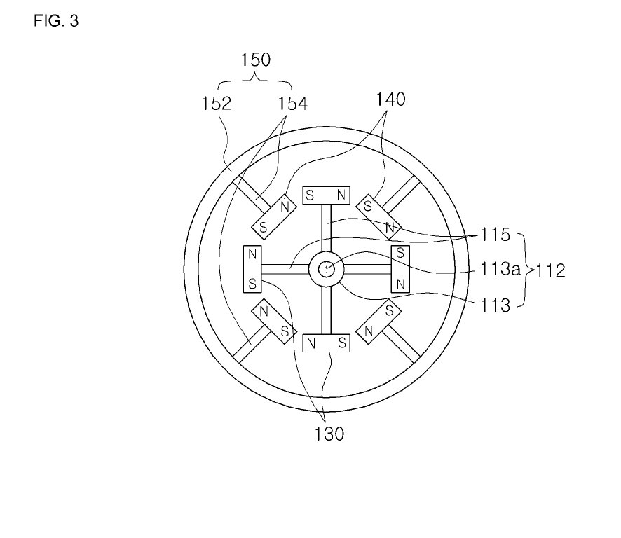

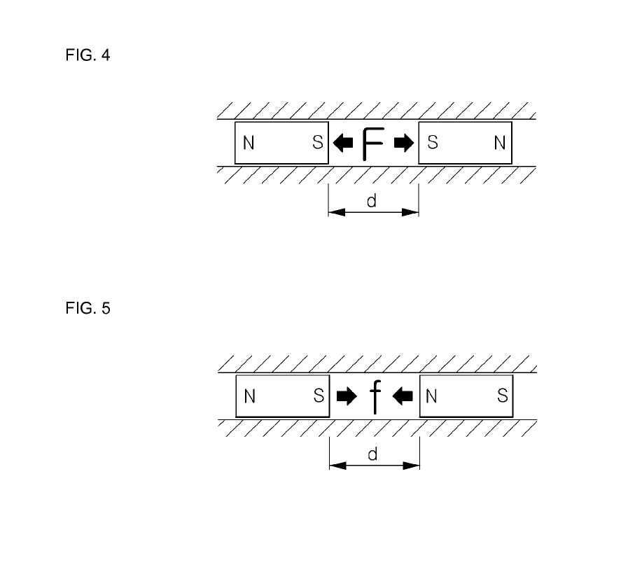

FIG. 1 is a diagram of a torque measuring apparatus 100 using magnetic bodies, according to an embodiment of the present invention, FIG. 2 is a diagram showing an arrangement of a first magnetic body 130 and a second magnetic body 140 disposed in an output link 150 of FIG. 1, according to an embodiment of the present invention, FIG. 3 is a diagram showing an arrangement of the first magnetic body 130 and the second magnetic body 140 disposed in the output link 150 of FIG. 1, according to another embodiment of the present invention, FIG. 4 is a diagram of a state where a repulsive force is generated between the first magnetic body 130 and the second magnetic body 140, and FIG. 5 is a diagram of a state where an attractive force is generated between the first magnetic body 130 and the second magnetic body 140.

Referring to FIG. 1, the torque measuring apparatus 100 includes an input link 110, a first displacement sensor 120, the first magnetic body 130, the second magnetic body 140, the output link 150, and a second displacement sensor 160.

One end of the input link 110 is connected to a driver 10, and the input link 110 is rotated in one direction by the driver 10. The input link 110 may be a connection shaft generally having a bar shape to transfer rotatory power of the driver 10, and the driver 10 may be a general motor for applying an external force to rotate the input link 110.

The input link 110 may have the one end at which the driver 10 is disposed, and the other end at which the first displacement sensor 120 is disposed. The first displacement sensor 120 may be disposed at the other end of the input link 110 to measure rotation displacement of the input link 110 and control the driver 10 that rotates the input link 110. The first displacement sensor 120 may include a separate controller (not shown) to control the driver 10.

A plurality of the first magnetic bodies 130 are disposed on an outer circumference of the input link 110, and are connected to the input link 110 via a connection member 112. The first magnetic body 130 may be a permanent magnet having a bar shape, but a shape of the first magnetic body 130 is not limited thereto and may vary.

The connection member 112 includes a cylindrical body 113 and a plurality of connection ends 115. The cylindrical body 113 has a through hole 113a through which the input link 110 penetrates, and the plurality of connection ends 15 protrude outside the cylindrical body 113.

The plurality of connection ends 115 protrude from corresponding locations of the cylindrical body 113, and may protrude in four directions from a circumferential surface of the cylindrical body 113. The connection end 115 has one end connected to the cylindrical body 113 and the other end adhered to the first magnetic body 130. A north pole and a south pole are respectively located at ends of the first magnetic body 130 based on a region adhered to the connection end 115, and the north and south poles may be located at the plurality of first magnetic bodies 130 in a same direction.

A plurality of the second magnetic bodies 140 are disposed between the plurality of first magnetic bodies 130 adhered in the four directions on the circumferential surface of the input link 110 by the connection member 112.

The second magnetic body 140 may also be a permanent magnet having a bar shape, and is disposed inside the output link 150. As shown in FIGS. 2 and 3, same or different polarities of the first and second magnetic bodies 130 and 140 may be adjacently disposed.

Referring to FIGS. 4 and 5, when the same polarities of the first and second magnetic bodies 130 and 140 are adjacently disposed, a repulsive force F wherein the first and second magnetic bodies 130 and 140 push each other is generated, and when the different polarities of the first and second magnetic bodies 130 and 140 are adjacently disposed, an attractive force f wherein the first and second magnetic bodies 130 and 140 pull each other is generated.

The repulsive force F and the attractive force f generated between the first and second magnetic bodies 130 and 140 are determined based on cross-sectional shapes of, material properties of, and a distance d between the first and second magnetic bodies 130 and 140.

For example, when the cross-sectional shapes are circular, a force between the first and second magnetic bodies 130 and 140 may be represented by a function of the distance d as follows.

$$F / f ( d ) = \frac{{μ}_{0} {Q}_{m}^{2}}{4 π} \{ - \frac{1}{{d}^{2}} + \frac{2}{{( L + d )}^{2}} - \frac{1}{{( 2 L - d )}^{2}} \} \qquad [ Equation 1 ]$$

Here, Qₘ denotes a magnetic moment, L denotes a length of a magnetic body, and d denotes a distance between magnetic bodies.

The plurality of first magnetic bodies 130 connected to the input link 110 that is rotated by the driver 10 are rotated in a rotating direction of the input link 110, and the plurality of second magnetic bodies 130 disposed between the plurality of first magnetic bodies 130 are also rotated in the rotating direction of the input link 110 by the repulsive force F and the attractive force f.

The output link 150 having the second magnetic bodies 140 inside thereof and supporting the plurality of second magnetic bodies 140 is also rotated in the rotating direction of the input link 110 as the plurality of second magnetic bodies 140 are rotated.

The output link 150 includes a body 152 and a plurality of protruding ends 154. The body 152 has a hollow shape, and the plurality of protruding ends 154 may protrude towards the inside of the body 152. The protruding end 154 has one end connected to the body 152 and the other end adhered to the second magnetic body 140. The plurality of protruding ends 154 may correspondingly protrude in four directions towards the inside of the body 152.

The second displacement sensor 160 is disposed on one surface of the output link 150. The second displacement sensor 160 measures rotation displacement of the output link 150, and may be closely adhered to the one surface of the output link 150. The second displacement sensor 160 may smoothly measure the rotation displacement of the output link 150 by being closely adhered to the one surface of the output link 150.

The first and second displacement sensors 120 and 160 may be a general synchro, a resolver, a rotary encoder, or a pulse generator.

The rotation displacement of the output link 150 is measured by the second displacement sensor 160 and substitutes for Equation 1 about a force according to a shape of a magnetic body, and thus an external force may be easily measured.

As such, the torque measuring apparatus 100 may measure an external force without having to use a general apparatus having a complex structure and a large volume, such as a load cell or a strength gauge. Also, since the torque measuring apparatus 100 has a simple structure, it may be miniaturized and lightened, and thus may be conveniently used by being directly applied to any one of various medical apparatuses or industrial machines, or a rotation shaft of a tool.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A torque measuring apparatus using magnetic bodies, the torque measuring apparatus comprising:
an input link whose one end is connected to a driver and rotated in one direction by the driver;
a first displacement sensor disposed at the other end of the input link, and controlling rotation displacement of the input link and the driver;
a plurality of first magnetic bodies connected to the input link via a connection member and rotating in the one direction;
a plurality of second magnetic bodies disposed between the plurality of first magnetic bodies;
an output link supporting the plurality of second magnetic bodies and rotated by the pluralities of first and second magnetic bodies, wherein the plurality of second magnetic bodies are disposed inside the output link; and
a second displacement sensor closely disposed to one surface of the output link and measuring rotation displacement of the output link.

2. The torque measuring apparatus of claim 1, wherein the connection member comprises:
a cylindrical body having a through hole through which the input link penetrates; and
a magnetic body protruding outside the body and comprising a plurality of connection ends connected to the plurality of first magnetic bodies.

3. The torque measuring apparatus of claim 1, wherein the output link comprises:
a hollow body; and
a magnetic body comprising a plurality of protruding ends protruding inside the body to support the plurality of second magnetic bodies.

4. The torque measuring apparatus of claim 1, wherein the pluralities of first and second magnetic bodies are adjacently disposed, wherein same polarities of the pluralities of first and second magnetic bodies are adjacently disposed.

5. The torque measuring apparatus of claim 1, wherein different polarities of the plurality of first and second magnetic bodies are adjacently disposed.
